(19) United States
(12) Patent Application Publication
(10) Pub. No.: US 2016/0162592 A1
(43) Pub. Date: Jun. 9, 2016

(54) Systems And Methods For Performing Task Using Simple Code

(71) Applicants: Chian Chiu Li, Fremont, CA (US); Xin Li, Toronto (CA)

(72) Inventors: Chian Chiu Li, Fremont, CA (US); Xin Li, Toronto (CA)

(21) Appl. No.: 14/961,901

(22) Filed: Dec. 8, 2015

Related U.S. Application Data
(60) Provisional application No. 62/089,827, filed on Dec. 9, 2014.

(51) Int. Cl. G06F 17/30; G06K 19/06

(52) U.S. Cl. CPC G06F 17/30876; G06K 19/06037

(57) ABSTRACT

Systems and methods for performing task by entering a simple code. Combination of a unique marker and a simple code is arranged to represent a task, such as logging on a website or making a phone call. Marker info is arranged to be acquired automatically or through verbal input. Distinctive marker info may include location, time, image, object, entity, or combination. A simple code may include a one-digit, two-digit, or three-digit number. A user only needs to key in a simple code to execute a task.

### CROSS REFERENCE TO RELATED APPLICATION

This application claims the benefit under 35 U.S.C. Sec. 119 of provisional patent application Ser. No. 62/089,827, filed Dec. 9, 2014.

### FEDERALLY SPONSORED RESEARCH

Not applicable

### SEQUENCE LISTING OR PROGRAM

Not applicable

### BACKGROUND

1. Field of Invention

This invention relates to executing a task electronically, more particularly to executing a task, such as accessing online info or making phone call, through entering a simple code.

2. Description of Prior Art

As more and more information is provided or published on the Internet, easy access of online info becomes increasingly desirable. So far going directly to a website via a browser is the most used method to retrieve information online. For instance, if info is needed for a product of a store, we may visit the store's website looking for a relevant page. Accessing a website requires the knowledge of website address, or uniform resource locator (URL). A user may enter a URL manually or search for the website using key word. But for most people, keying in URL's long string of letters and signs on a device, especially on a smartphone with a small virtual keyboard, is inconvenient and frustrating. And opening a search page, keying in key word, and starting a search process may cause several steps and may be frustrating as well. In fact, people tend to avoid keying in words, especially unfamiliar words or string whenever possible. Another access method involves code scanning using, for instance, a phone camera and certain application. For example, there are products and printed materials which carry a quick response (QR) code. QR code is a two-dimensional barcode which may contain URL and other information. After a QR code is scanned by a smart phone, with appropriate app, the phone may be directed to a website determined by the QR code. Then the phone may download data from there, and display a webpage. In the process, scanning causes the phone to display contents automatically and there is no need for user to enter anything. However, although QR code brings some convenience, scanning a code itself is still awkward and demanding. For instance, a user may have to hold a smartphone firmly, aim at a code precisely, and then wait for a qualified scan to take place. The scan process requires time, some skill, and patience, which is not well accepted by some users.

Therefore, there exists a need for easy, quick, and convenient access of online information.

At times, people make phone calls to reach a business or organization for information or participation of certain program. A phone number may come from TV commercial, radio advertisement, magazine ad, or newspaper ad. The number, new and unknown, has to be remembered temporarily and most likely would be used only once. For most people, memorizing a phone number is not an easy job. It is both intimidating and challenging, in particular when a number is briefly shown on television screen or announced on the air only once or twice. As a consequence, calling a business, which may be promoted in advertisement costly, is actually hindered by the advertised info, i.e., the long phone number. In addition, tapping a long phone number is also boring and demanding.

Therefore, there exists a need for easy, quick, and convenient way to call an unfamiliar number.

Since both accessing online information and making phone call are executable tasks for certain electronic devices, such as smartphone, aforementioned needs may be summarized as a need for performing a task easily and conveniently.

### OBJECTS AND ADVANTAGES

Accordingly, several main objects and advantages of the present invention are:
a). to provide improved method and system for doing a task, like accessing online information or making phone call;
b). to provide such method and system which combine a distinctive marker with a simple code to represent a task exclusively;
c). to provide such method and system which use the info of location, time, object, entity, image, or combination as a distinctive marker;
d). to provide such method and system which obtain marker info automatically or through verbal input of user;
e). to provide such method and system which enable a user to do a task by entering a simple code; and
f). to provide such method and system which make performing a task easy, quick, and convenient.

Further objects and advantages will become apparent from a consideration of the drawings and ensuing description.

### SUMMARY

In accordance with the present invention, methods and systems are proposed for performing a task, such as accessing online info or dialing a phone number, with ease and convenience. A task may be implemented using a simple code. A simple code may be combined with a distinctive marker to represent a task. Marker info may be obtained automatically or through verbal input. A user only needs to enter a code, through manual or verbal method. Once code and marker info is transmitted to a facility, a corresponding task may be retrieved and executed, such as sending message to a device and causing the device to log on a web page or make a phone call. Distinctive marker info may include location of device, time, object, entity, image, or certain combination. Since a user only needs to deal with a simple code, performing a task may become easy, quick, and convenient. Consequently, many tasks, such as accessing online info or calling a number, may become easy and convenient to start out.

### DRAWING FIGURES

FIG. 1 is an exemplary block diagram describing one embodiment in accordance with the present invention.

FIG. 2 is an exemplary flow diagram showing one embodiment of task representation in accordance with the present invention.

FIG. 3 is an exemplary flow diagram showing one embodiment of accessing online information in accordance with the present invention.

FIG. 4 is a table showing examples of simple code in accordance with the present invention.

FIG. 5 is an exemplary flow diagram showing embodiments with different markers in accordance with the present invention.

FIG. 6 uses exemplary diagrams to show one embodiment using simple code to access web info in accordance with the present invention.

FIG. 7 is an exemplary flow diagram illustrating embodiment of making phone call with a simple code in accordance with the present invention.

FIG. 8 shows exemplary diagrams illustrating embodiment of making phone call using verbal input in accordance with the present invention.

REFERENCE NUMERALS IN DRAWINGS

| | | | |
|---|---|---|---|
| 10 | Sensor | 12 | Device |
| 14 | Processor | 16 | Computer Readable Medium |
| 18 | Sensor | 20 | Sensor |
| 22 | Poster | 24 | Smartphone |
| 26 | Device | | |

100, 102, 104, 106, 108, 110, 112, 114, 116, 118, 120, 122, 124,
126, 128, 130, 132, 134, 135, 136, 137, 138, 140, 142, 144, 146,
148, 150, 152, 154, 156, 158, and 160 are exemplary steps.

### DETAILED DESCRIPTION

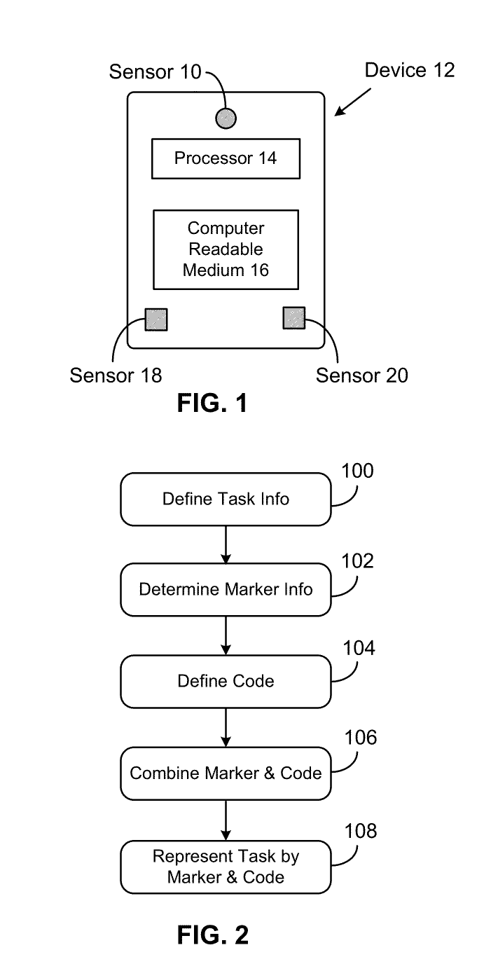

FIG. 1 is an illustrative block diagram of one embodiment according to the present invention. A device 12 may represent an electronic device, including but not limited to smart phone, smart watch, wearable device, handheld computer, tablet computer, virtual reality (VR) device, augmented reality (AR) device, and the like. Device 12 may include a processor 14 and computer readable medium 16. Processor 14 may mean one or more processor chips or systems. Medium 16 may include a memory hierarchy built by one or more memory chips or storage modules like RAM, ROM, FLASH, magnetic, optical and/or thermal storage devices. Processor 14 may run programs or sets of executable instructions stored in medium 16 for performing various functions and tasks, e.g., surfing on the Internet, placing phone call, placing online purchase order, playing video or music, gaming, electronic payment, social networking, sending and receiving emails, short messages, files, and data, executing other applications, etc. Device 12 may also include input, output, and communication components, which may be individual modules or integrated with processor 14. The communication components may connect the device to another device or a communication network. Usually, Device 12 may have a display (not shown in FIG. 1 for brevity reason) and a graphical user interface (GUI). A display may have liquid crystal display (LCD) screen, organic light emitting diode (OLED) screen (including active matrix OLED (AMOLED) screen), or LED screen. A screen surface may be sensitive to touches, i.e., sensitive to haptic and/or tactile contact with a user, especially in the case of smart phone, tablet computer, smart watch, and some wearable devices. A touch screen may be used as a convenient tool for user to enter input and interact with a system. Furthermore, device 12 may also have a voice recognition component for receiving verbal command or audio input from user. For VR or AR device, it is impractical to touch a real screen. Thus, virtual screen, verbal command, or gesture instructions may be useful for users.

A communication network which device 12 may be connected to may cover a range of entities such as the Internet or the World Wide Web, a local area network (LAN), a wide area network (WAN), a metropolitan area network (MAN), a telephone network, an intranet, wireless, and other types of networks. Device 12 may be connected to a network by various wired, wireless, optical, infrared, ultrasonic or other communication means. Via a network, device 12 may communicate with a remote facility or service center, send data, receive data, or engage interactive acts.

Device 12 may include a sensor 10 which may be a camera, such as rear-facing camera of smartphone. The camera may be arranged to take pictures as well as scan QR code, one-dimensional barcode, and other machine-readable code with the help of certain application.

Device 12 may also include a sensor 18 which is a near-field communication (NFC) device. NFC is of short-range wireless communication technology and may be employed to read radio-frequency identification (RFID). RFID is a wireless technology for the purpose of transferring identification data passively or actively. A RFID tag may be made very small in size, e.g., smaller or much smaller than one millimeter. It may be placed, for instance, at a designated convenient place at a store, or embedded in a product, for instance, in a magazine. Assume that store RFID contains info of the store. If a store RFID tag is read or accessed by a user device, it may mean that the user is at the store and a store marker may take effect immediately. If a RFID tag embedded in magazine is accessed, it may mean a magazine marker is taken and the marker may remain active for a given period of time.

Furthermore, device 12 may carry a positioning sensor 20. Sensor 20 may be a global positioning system (GPS), which enables a device to get its own location info. Device position may also be obtained using wireless triangulation methods, or via a system using other suitable technologies, which may be arranged by a service provider or service facility. Usually for indoor or some urban environment, positioning methods other than GPS are used, since GPS requires a clear view of the sky or clear line of sight for four GPS satellites.

Inside device 12, output signals of sensors may be transmitted to processor 14, which, employed with certain algorithm, may process the data and send messages to a specific application responsible for working with it. The application may process the messages and proceed accordingly, such as transferring certain info to service center, waiting for instructions or task from the center, and then implementing instructions or carrying out a task.

FIG. 2 is a schematic flow diagram showing one embodiment of representing a task by marker and code. Usually a task is a task. Doing a task means executing a program or application which is designed for implementing it. Take smartphone for instance. A user may go to a particular page, find a corresponding app, and launch the app. If the app is a browser, a user may enter a website address, and then tap enter button. The whole process may be boring and frustrating. FIG. 2 introduces an embodiment which uses marker and code to represent a task for public use. With such arrangement, a task may be accessed and performed easily and conveniently. For instance, a marker may be obtained automatically. A user may only need to enter a simple code. A task may be performed after a code and marker are received. To represent various tasks, each marker is designed unique. When a unique marker is bundled with a code, even a simple code, the combination becomes unique as well. Thus, simple code plus marker may represent a task exclusively. A marker may be selected such that it may be acquired automatically via user device such as smartphone or service provider. A code may be simple and easy to remember. A code may be of a number, a letter, a sign, a character, a word, an icon, or any combination of them. It's obvious that a very simple code has a single-digit number, single letter, or single sign. A marker may be anything which represents a distinctive feature related to a target object or task. A marker may be shared by a number of objects or tasks. Examples of marker may include location of device, a time period, an object, an entity, an image shown on VR or AR device, or a combination of different features like location plus time, or entity plus time. Location and time data may be collected automatically by user device, service provider, or on-site sensing facility. Object and entity data may be obtained via RFID or code-scanning method. RFID info may be gathered by placing a reader device close to a RFID tag, with tolerable effort. But since QR code and bar code require manual work, they are useful but not as convenient to use as codes obtained automatically.

Back to FIG. 2. In Step 100, a task which needs representation is defined. Next in Step 102, a distinctive marker is determined. The marker may fit the application of the task and may be conveniently acquired when needed. In Step 104, a code is decided. A code may nominally stand for a task of interest. A code may be short, simple, and unique, though the uniqueness only applies to codes under one marker. In Step 106, the marker and code are combined. The combination may be assigned to represent the task in Step 108. For instance, a store location is unique and may be used as marker. If three digits are used for code, there are one thousand distinctive codes and thus one thousand combinations of marker and code, where each combination is unique. If marker plus code are used to represent products at the store, one thousand products may be covered. In application, it may be designed that when a code is entered at a user device by a user at the store, the code is automatically bundled with the store location marker. The code and marker may be sent to service center, which may find out which task is represented by the two elements. Then, a corresponding task may be obtained and sent to the user device. The task may be of accessing a web page and presenting information of a product which is associated with the code. In practice, a marker may be arranged to be acquired automatically, such that a user only needs to enter a simple code, which may create an easy and convenient experience. Because a marker may be handled automatically, a user may have no need to deal with it. On the other hand, a code is arranged to be entered by user. Thus code info needs to be displayed publicly, while marker info may not. Among task, marker, and code info, only task and code info needs to be presented publicly for public use.

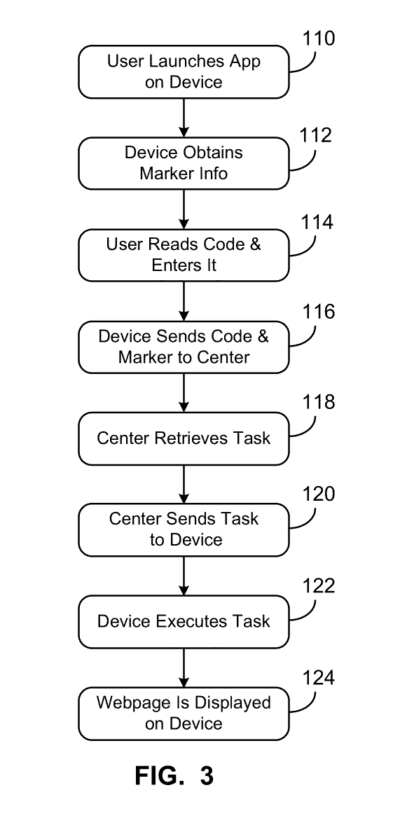

FIG. 3 is a schematic flow diagram showing one embodiment of executing a task, or obtaining online information using a simple code. In Step 110, a user opens an app to start a process at a device. Normally, logging on a website on the Internet means launching a browser and entering URL or website address. The task may be simplified by entering an easy code like “123” or even a single-digit number like “1”. In Step 112, marker info is obtained, which may be completed automatically by the device via the app or a service provider via a program. For instance, if the device contains GPS, location data may be collected automatically. Location data and time data may work as marker info. In Step 114, the user may find a code and enters it on the device. The code and task info are arranged on display to let user know the nature of task and how to do it. Since location and time data is not handled by user, there is no need to display it. For instance, a sentence like “Please tap 123 to log on our website” may be displayed. Here “log on our website” is a task, and “123” is the code. In Step 116, the marker and code info may be sent to service center to locate a predetermined task. Next in Step 118, the center may use the marker and code to find a task at a database. The task may include instructions to log on a website which contains the desired info. Then the center may transmit the task to the device in Step 120, and the device may start the task in Step 122. Finally in Step 124, the task is performed, and the device may log on a web site. After data is downloaded, the device may display a web page with information which the user is looking for.

The scheme illustrated in FIG. 3 provides an easy, quick, and convenient way to execute a task, as a user only needs to key in a simple code. Tasks may be prearranged to cover a wide range of assignment, including, for example, placing a phone call, communicating to another device, starting a specific program, etc. Thus, with a simple code such as “123” and automatically obtained marker, various tasks may be pursued and accomplished. In the following, more discussions and details are presented.

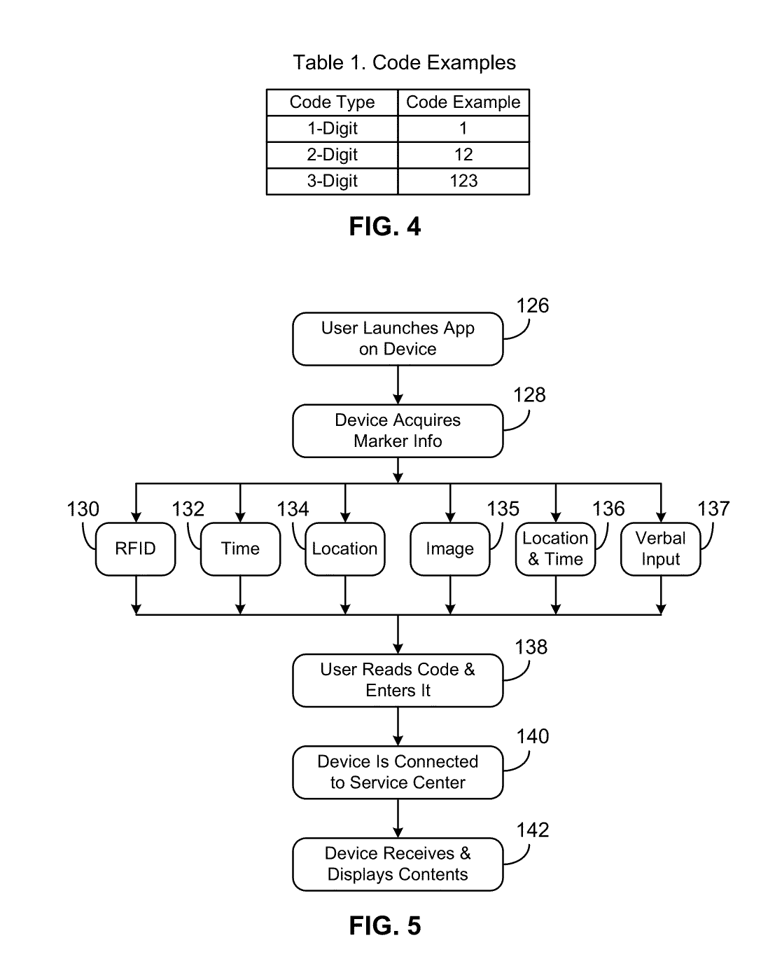

FIG. 4 shows a table illustrating three types of simple code exemplarily, including one-digit, two-digit, and three-digit numbers. One-digit code is of the simplest type. A single-digit code may be used in multiple places simultaneously, and may still be unique when combined with a distinctive marker at each place. As a code may also include letter, character, icon, or sign, any single item of them may be used as code too. A code with three digits or less may be especially desirable for television and radio commercials due to the ease of handling, and its advantage is obvious compared to a ten-digit phone number. When a code contains letter, character, icon, or sign, an inputting tool like touch screen may be arranged for the convenience of entering it. If voice recognition technology is available, a code may be submitted verbally by user. For instance, after a code app is on, a user may say a code to a device.

FIG. 5 shows a schematic flow diagram of accessing online information with emphasis on markers and methods to get marker. A distinctive marker, combined with a simple code, may be used to represent any task exclusively. For instance, two tasks may be represented respectively by two markers with the same code, or two codes under the same marker. As there is limited quantity of simple and easy-to-remember code, arranging unique markers is important. Furthermore, marker info is better obtained automatically so that a user may only need to enter a simple code, which may make the process of performing a task easy and convenient. When a marker is not acquired automatically, verbal input may be used as a convenient alternative, as saying is much easier than keying in. As marker info may be automatically taken or known to user, like marker of home, there is no need to present marker to user. Only task and code info needs to be displayed publicly, so a user may easily know what a task is and what code to enter to do the task.

One choice of marker is location, as a location is unique by itself, and location info can be obtained automatically by GPS or other methods. A location may be a business periphery, a place of an organization, an event site, user's home, a public venue, etc. Location marker may also be arranged to cover a region, such as town, city, state, or country.

Another choice of marker is time. Time is also unique and thus may be used to define an applicable range. Time data is also easy to get, as most devices have an internal electronic clock. Time-dependent marker may contain a start and ending point to specify a time period. When location and time info are combined, they may form another kind of marker defined by a place and a time period together. For instance, at a store, a code may represent one product at one time, and the same code may represent another product at another time. Here the marker has both location and time factors.

In addition, RFID tag may be designed to contain marker info which may be associated to all kinds of objects or entities, such as a product, an organization, or anything. A device may get RFID data via NFC sensor and take marker info from it. After that, when a code is entered by a user within a given time period, the code and marker info may be combined. The bundled info may be transmitted to a remote center. The center may locate a task based on marker and code data and proceed as instructed by the task.

For VR and AR device, images and programs are presented to users individually. Each image or program may be used as a marker. For instance, assume a VR device is connected to the Internet. The device shows an image. The image contains an object with a code displayed. It may be designed that when a user submits the code on the VR or AR device within certain time after presentation of the image, the code and the image marker may be sent to service center. Then a task may be retrieved and transmitted to the device. Following instructions of the task, the device may log on a web page which may contain info on the object. It is noticed that VR and AR devices may use afore-mentioned markers like location marker and time marker or markers used by other devices as well.

Returning to FIG. 5. First, a user starts an app in Step 126. Next in Step 128, marker info is obtained. As discussed, there are several ways to gather marker info. In Step 130, RFID method is used. RFID data may be collected by a NFC sensor like sensor 18 of FIG. 1. Once RFID info is obtained, its marker content is retrieved by the app. The marker may remain valid in a certain time period or until another marker is invoked. Thus, a marker from RFID is actually valid only during a limited time period. Besides, RFID tag may be designed to work in a predetermined time slot, so that only code entered in certain time period may be combined with marker info to invoke a pre-arranged action. In Practice, RFID tag may be used to label a magazine, a book, or an object which circulates with a broad and fuzzy location and time range. And codes may be provided in a magazine, book, or on an object for further information on the Internet. A user may access a RFID tag, and then enter a code to reach an online source easily and conveniently.

In Step 132, time is enlisted as marker. Time info is readily available for many devices. So any code entered by a user may be associated with a time marker. A specific time plus a code may form a distinctive label which may prompt a device to initiate a pre-scheduled program. As time marker may cover many places, a code arranged with it shall be selected carefully so as not to point to multiple tasks at the same time. A time marker is useful for situations where time is an important indicator, while location plays a minor role. For instance, a time marker may be used in a radio advertisement. No matter where a listener is located, after an app is launched on a smartphone, a user may enter a simple code to access a specific web page, or dial a specific phone number. Thus instead of entering a complicated web address or a long phone number, a listener may just need to key in a couple of digits.

Step 134 introduces location marker. Location info may be measured by GPS like sensor 20 of FIG. 1. The info may also come from a service facility through a program. Location marker has a fairly clear geographical coverage. For example, a store location marker may be designed to work inside a store only. A code entered on a device may be combined with the marker to fetch product information or perform certain task arranged by the store. For instance, if a product has a code 11, keying in 11 on a smart phone may open a browser and display a webpage showing info of the product. Therefore location marker and simple code may allow merchants to provide easy-to-get info and easy-to-do task for improved shopping experience.

Step 135 is designed for VR or AR devices which may show contents to users individually and exclusively. When a VR or AR device presents an image or video clip, the presentation itself may be used as marker. For instance, when an image is displayed, a code may be assigned to an object in the image and presented. After a user sees and then enters the code, the device may send it along with an image ID to service center. Thus a task may be retrieved and sent back to the device. The device may also be arranged to transmit code and time data to service center. The center may find image info based on the time from a service provider, and retrieve certain prearranged task accordingly.

In some cases, a code may be designated to point to an object for a long time. But a code used in some other cases may represent a thing for a short time period. For instance, a code for an ad printed on newspaper may be arranged valid for a few days or a week only, as a copy of newspaper may be forgotten after a day or two. Thus for certain applications, a marker may have two limiting factors: Location and time, which is reflected in Step 136. First, the app acquires location and time data as marker info. Once a user enters a code, the marker and code may be added together to point to a task which matches the three conditions. A location & time marker is also useful for airport, school, and convention site, where things change over time frequently. Changing with time makes the main difference between a location marker and location & time marker. In the former case, there may be no need to check time, while in the latter situation, both location and time data are required to seek a matching action item.

Step 137 illustrates another method to get marker info which utilizes verbal input of user. Unlike others introduced, a marker from verbal message is not automatically obtained, since a user has to say something. But it's still convenient, as with voice recognition technology, a user may easily and quickly say one word or a short sentence to submit marker or code info. For instance, a user may speak to a device “home” to set up a marker for home and then enter or say a code to carry out a task. A user may also say the name of a magazine. After a device receives the verbal message and identifies the magazine, a marker of magazine is obtained. Then codes entered on the device may be combined with the marker within a given period of time. Assume that simple codes are provided for online info of the magazine. A user may access the online info easily and conveniently by keying in or speaking a simple code. Verbal input may be applied to all devices equipped with voice recognition technology, including VR and AR gadgets. Like markers prepared for RFID method, markers arranged for verbal method may include a wide range of objects and entities, such as location, product, organization, community, event, activity, or anything which is suitable for marker role.

An app on a device may be designed to work with various markers. For instance, after it is turned on, an app may start gathering info. First, it may record the time. Then, location data may be obtained through GPS sensor or from a service facility. For example, if a user is at an indoor mall, where GPS method is no longer used, he or she may rely on Wi-Fi-based positioning system (WPS) provided by the facility to get location info. Next the app may await input of code from the user. If a code is received, the app may send to service center info of time, location, and code. Then the center may start searching for a pre-determined task which may match the marker and code info at a database. Alternatively, the center may check whether there is a location marker for the location, or a time marker, or a location & time marker, and then use code info to find a task.

While an app is awaiting user input, a NFC sensor may be turned on. If a RFID tag is detected and it contains marker info, the marker may have higher priority in case a location marker with the same code produces another result.

In Step 138, the user may find a code and enter it on the device. Next in Step 140, the device may log on a website of service center and start sending data to the center. The data contains marker and code info, which may cause the center to find a task accordingly. For instance, there may be a database storing information related to task, marker and code at a service facility. For every pair of marker and code, there exists an action item. A server at the facility may retrieve one action item and proceed by taking instructions contained in the item. The instructions may include certain actions executable by the service facility, like getting back to the device with a task attached, or sending message to another device which is away from the user and facility and causing it to act in certain way. In Step 142, the device may act according to the message received from the service facility. For instance, the message may arrange the device to fetch information from a website, and then display it on a screen.

Since marker info may be taken through different methods or from different sources, it may be designed that a method or origin used is sent to service center as well. For instance, location info may be gotten through GPS method, RFID method, or verbal input, which corresponds to marker origin of GPS, RFID tag, or user respectively. So it may be desirable for some business to know how often each method is used to obtain location data. Sometimes, a device may obtain its location marker automatically and send the info to service center. After a while, a user may speak to the device to submit a different location. In such a case, the device may send new location info and method used to service center. The center may overwrite marker info obtained from measurement and update it with user-provided data if the center knows it is from a user. Thus it may be designed that marker info, which is sent from a device or facility to service center, includes content of marker and method or source used to get the content.

Similarly, as code info may come from key-in process or verbal input, a code sent to service center may be attached with a note identifying which method is used. Such info may be useful for some business, as it is related to user's habit and tendency.

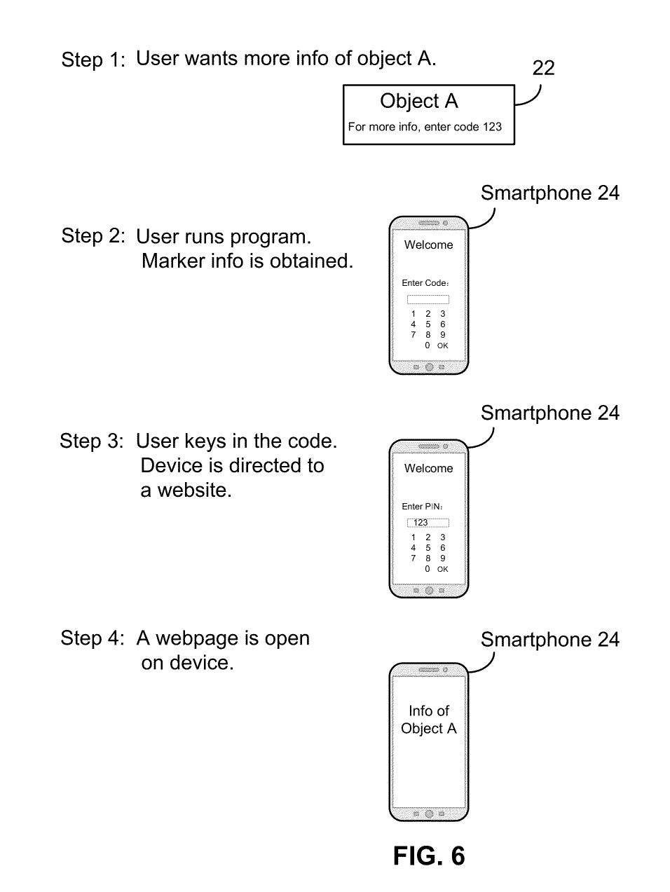

FIG. 6 uses graphic diagrams to show another embodiment of getting online information via a simple code in an easy and convenient way. Assume a smartphone 24 is used in a retail, convention, or amusement park setting. It starts with Step 1 when a user finds an object A and wants to know more information about it. The user notices that object A has a simple code 123 as displayed on a poster 22. The code is arranged for getting more information. In Step 2, the user may start an app on phone 24. The app may retrieve time and location info automatically. As the user is on a periphery of a business, a distinctive location marker may be identified. Next in Step 3, the user may enter code “123” on the phone. The app may cause phone 24 to send marker, time, and code data to a remote center. After searching a database, the center may retrieve a corresponding action item and then send a message to phone 24. The message may instruct the app to open a web browser and visit a specific website which contains detailed information of object A. Then in Step 4, the app may make the phone download data from the website and display a webpage which presents contents related to object A.

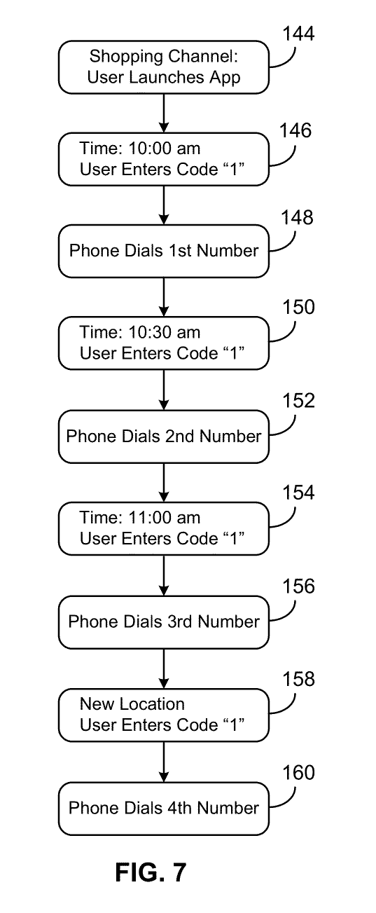

FIG. 7 depicts a schematic flow diagram of dialing experience. Assume a user is at home watching a shopping channel on television on Saturday and begins purchasing process by launching an app on a smartphone in Step 144. Assume that the user is interested in a product presented on TV at 10:00 am. The TV screen shows a ten-digit contact phone number, a single-digit contact code “1”, and a message “To place an order, please call us or press “1”.” The task is to place order and the code is a single-digit number “1”. A user may dial the phone number to start it. But with the app, a user may only need to enter code “1” on the phone, as shown in Step 146. After that, the app may transmit the code and time info to service center along with location info. The location info may be collected automatically or retrieved from a service provider. Next, the center may find a matching task. The task may request the center to send pre-arranged instructions to the phone. The instructions may contain the phone number and a dialing request. After the app receives the instructions, it passes the message to a processing system. Next the phone starts dialing the phone number in Step 148. Then the user may place a purchase order over the phone. Now the time is 10:30 am in Step 150, and the user may become interested in another product shown on TV. The user notices that the code is still “1”. Thus the user may tap “1” and once again the phone may be ready to start a dialing process. In Step 152, the phone may receive and call a second phone number. It is seen that the code remains the same, but the task changes. This is because the time marker let the code point to another action item based on time data. Next the user may talk to a sales representative and complete a purchase.

At 11:00 am, the shopping channel may present more products and the user may become interested in purchasing again. Assume the code for a new product is still “1”. Thus the user keys in “1” one more time in Step 154. Like previous cases, after service center receives the code plus time and location info, it may obtain a corresponding action item. Then the center may send a message to the phone and cause the phone to dial a third phone number in Step 156. Once the call goes through, the user may start another shopping round.

The next day, the user may go to a warehouse to pick up products ordered over the phone. The place may have a location marker. The user may discover that he or she may tap code “1” to talk to a customer representative. Then code “1” may be entered on the phone in Step 158, and subsequently the phone dials a fourth number automatically in Step 160.

Above-mentioned examples indicate that a code under a time and location marker may be used multiple times and each time it may be arranged to invoke a different action.

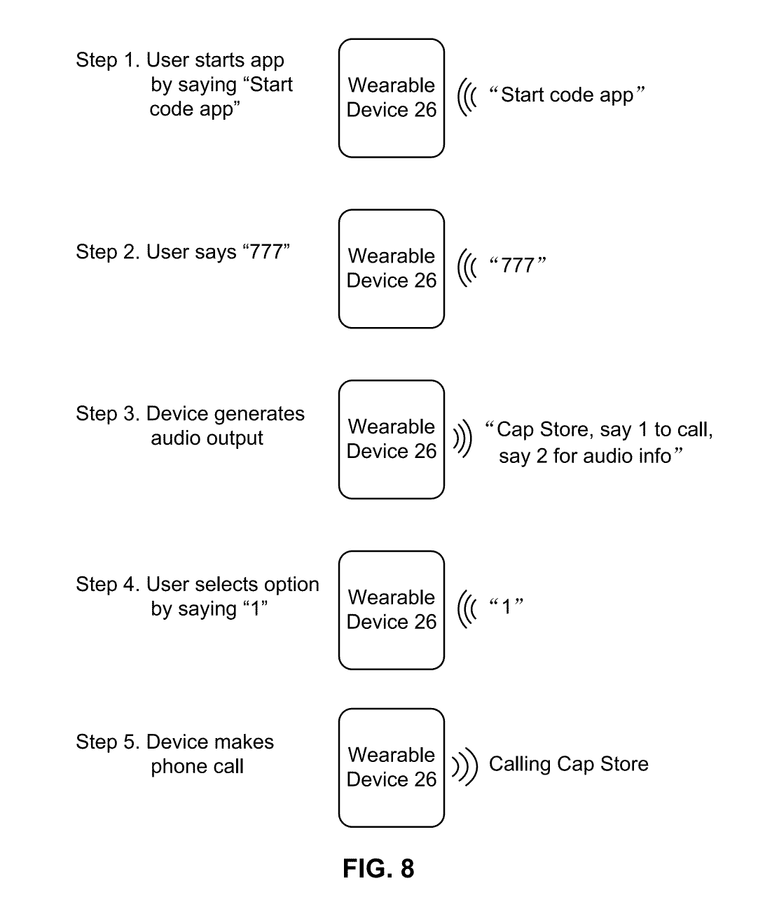

As wearable devices, such as smart watch, smart band, smart ring, and other small or tiny gadgets, may have a small screen or no screen, input and output using touch screen may become awkward or unavailable. In such scenarios, verbal method may become an important input tool. A user may give verbal or audible instructions, and a device may generate audio output. Instructions may be of a simple code, a short name, or a short sentence, which may be easy and quick to say. FIG. 8 shows graphic diagrams of an embodiment using verbal input and audio output. Assume that a user may be watching a commercial in which a shop named “Cap Store” promotes its newest products. The user may see a contact code “777” shown on television screen. Then in Step 1, the user may say “Start code app” to a wearable device 26 to launch a code program, assuming the device has voice recognition capability. Alternatively, it may also be designed to start the program by shaking device 26 a bit and then speak to it, or tapping the device a couple of times and then speak to it. The shaking or tapping act may be designed to alert device 26 and make it start voice recognition process. Next in Step 2, the user may give instructions by saying the code “777”. Device 26 may receive the voice message and convert it into a number by voice recognition algorithm. Then code and marker info may be transmitted to service center. The marker info may include location and time data which may be acquired already. Next service center may find a specific task in a look-up table stored in a database. The task may be passed to device 26. Then in Step 3, device 26 may perform the task and produce an audio output, such as “Cap Store, say 1 to call, say 2 for audio info”. The first sentence identifies the business name, Cap Store, to assure user. The second sentence means saying “1” may make the device call the store. The last sentence means saying “2” may bring an audio presentation about the store, which may include introduction, promotions, and more options. In Step 4, the user may say “1”. Then the device may call Cap Store in Step 5.

Audio interaction between a user and device has the merit of doing a task without using finger, and thus without the hassle of key-in. Simple code makes the process easy and convenient, since the content of input is reduced. A task may be arranged to have a voice version to suit the needs of audio process. The voice version may also be designed to generate less or none visual presentation. For instance, a user may register two versions for a task. A normal version works for smartphone and tablet computer, while a voice version for smartphone, tablet computer, and devices with a much smaller size. When a device sends code and marker info to service center, it may be designed to include a reference note too. The reference note is generated by device automatically and may let service center know it prefers audio process. For devices with very small screen or no screen, the reference note may always accompany marker and code info, while for other devices, a user may decide whether or not to sent it. After receiving a reference note, service center may retrieve and send a voice version of task to a device.

### CONCLUSION, RAMIFICATIONS, AND SCOPE

Thus it can be seen that systems and methods are introduced to execute a task using a simple code.

The improved method and system have the following features and advantages:
(1). A simple code may be combined with a unique marker to represent a specific task;
(2). A task, like accessing online info, making phone call, or placing order, may be initiated by keying in or saying a simple code;
(3). Distinctive marker info includes location, time, object, entity, image, or any combination; and
(4) Marker info may be acquired automatically or via verbal input.

Although the description above contains many specificities, these should not be construed as limiting the scope of the invention but as merely providing illustrations of some of the presently preferred embodiments. Numerous modifications will be obvious to those skilled in the art.

### RAMIFICATIONS

A simple code may be used to do many tasks. For instance, when a user wants to look at user's manual of an appliance, the user may use a simple code to get connected to a website containing the info. For home appliance such as refrigerator, air conditioner, alarm system, a code may be printed on a label, which may be seldom noticed and rarely picked up. A code for such cases may contain a unique sign to distinguish it from other code. The sign may be arranged to show up on a code app interface only when a home marker is in effect. The sign may mean the code is for appliance use.

At a bus stop, a simple code may be used to get bus schedule and possibly the estimated arrival time of the next bus.

A sign may be used as marker, code, or part of code. For instance, certain signs may be arranged beside a virtual or soft keyboard in a code input window so that a user may tap a sign conveniently when keying in number and/or letter. Examples of sign may include “home” icon for home, fork and knife representing restaurant, car sign for taxi service, bus icon for bus stop, or a logo for a business. Here a sign may be considered as either marker or part of a code and it doesn't make a difference in terms of effect, as the goal is to make a distinctive label to tag a task. When a sign is used for code, it may be of part of a code, since the other part may be a number. For instance, when a user is looking for a place around lunch time, he or she sees a simple code posted on the door of a restaurant. The user may start an app on a smartphone, tap a restaurant sign and then enter the code. Next the code, time, and the sign info may be sent to service center. A corresponding action item may be found and then a message may be sent to the phone. The message may contain information of the restaurant or cause the phone to log on a website of the restaurant. A sign may help pinpoint a task and may be useful when location marker is unavailable or not distinctive enough due to the issue of positioning resolution. As there may be lots of signs for various businesses or entities, it may become obtrusive if many of them are presented on a display screen. So it may be arranged that a sign may only show up on screen when it is likely to be used. Appearance of sign may be controlled by code app or service center based on marker info and potential tasks a user may be interested in, since marker info and potential tasks are connected by signs. For instance, when it is detected that a user is on a street in downtown area, it may be assumed that the user could need taxi service. Then a taxi sign may show up on a code app interface. A user may tap the sign and then a simple code to contact a preferred taxi company. Here a sign may be a logo, an icon, a letter, a word, an image, or a picture. As aforementioned, an easy-to-use code may be a one-digit, two-digit, or three-digit number. Since a sign may be easy to recognize, handle, and remember, it may be arranged that a code may contain a sign plus a one-digit, two-digit, or three-digit number only. For instance, when entering a code on a touch screen, a user may tap a sign first, followed by tapping at most three digits to complete code input process.

A simple code may also be used to carry out a task on another device. For instance, a product at a store may have two codes, one for fetching product-related info, which is discussed already, and the other for placing the product in a virtual shopping cart for purchase purpose. In the latter case, service center may follow instructions of a task and send a message to a store system notifying it of the purchase request. The store system may be located at another remote place. It may take it over and add the product to a shopping cart for the user. The user then may arrange payment method and have the store ship the product to an address. The interaction between a store system and a user device may be carried out directly, or arranged via service center. In the former case, the store system and user device are connected and may talk to each other directly. In the latter case, they are not connected directly. Info transmitted has to go through service center, which passes it to a receiving party.

Similar to examples of getting online info, a simple code may be presented or advertised to make users visit a website, such as news portal, search engine site, gaming site, or file downloading site.

A simple code may also find use in surveys. For instance, a survey question “Do you like the show?” may be presented along with two codes on screen. One code is for “Yes” and the other for “No”. So a user may just enter a code to express opinion and doesn't need to go to a specific website to cast vote. Here location and time data may be of marker info. Code may also be used in a contest. For instance, a television screen may show that tapping “1” means voting for contestant 1, and tapping “2” means voting for contestant 2. After a user starts code app, home marker info is obtained. Then a “V” icon may appear on the code app interface, which may be caused by a message from service center. The message may be prearranged because of the contest event. Without the message, the “V” icon may not show up. The “V” icon may be part of marker or part of a code. To vote, a user may tap “V’ and then tap 1 or 2 on a virtual keyboard. Then marker and code info may be sent to service center. The center may find a matching task which may request the center to forward the info to a processing facility.

RFID may also be used as a store marker when positioning method is not accurate enough or not available. For instance, a user may swipe a smartphone in front of a RFID tag at a store counter to hook up with it to get marker info from RFID data. Then the user may tap simple codes displayed at the store to access information or perform online transactions such as reserving a product, booking service, checking promotions, and so on. The marker info may remain valid within certain period of time unless being cancelled or another marker becomes active.

Lastly, besides tapping or clicking buttons to key in a code of number, letter, or sign on a device, a user may also scribble number, letter, or sign on a touch screen to do the same job. When a sign is involved, it is assumed that the sign is suitable for scribbling.

Therefore the scope of the invention should be determined by the appended claims and their legal equivalents, rather than by the examples given.

1. A method performed for representing a task for public use, comprising:
1) defining first info including said task, marker info, and a code;
2) said marker info arranged to be collected electronically using a predetermined method, said marker info defined by at least one of a plurality of factors, said plurality of factors including a geographic location, a geographic region, an object, an entity, an image, and a time period;
3) said code arranged to be submitted by a user, said code including at least one element, said at least one element including a numeric number, a letter, a character, or a sign;
4) said marker info and said code arranged respectively;
5) arranging the combination of said marker info and said code to represent said task; and
6) presenting said first info except said marker info publicly.

2. The method according to claim 1, further including determining at least one method for said user to submit said code.

3. The method according to claim 1 wherein said task is arranged to be initiated by said user using said code.

4. The method according to claim 1 wherein the info of said object or entity is associated with a machine-detectable signal.

5. The method according to claim 1 wherein the info of said object or entity is associated with verbal message of said user.

6. The method according to claim 1 wherein said code is associated with verbal input of said user.

7. The method according to claim 1 wherein said marker info is arranged to be collected by a device in an automatic manner.

8. A method performed for handling a plurality of tasks respectively, comprising:
1) arranging a data structure comprising a plurality of markers, a plurality of codes, and said plurality of tasks, said data structure arranged using a first device;
2) said plurality of markers each defined by at least one of a plurality of factors, said plurality of factors including a geographic location, a geographic region, an object, an entity, an image, and a time period;
3) said plurality of codes each including at least one element, said at least one element including a numeric number, a letter, a character, or a sign;
4) obtaining one of said plurality of markers, the info of marker acquisition method, and one of said plurality of codes from a second device or a second device and a facility;
5) retrieving one of said plurality of tasks based on the info received from the obtaining step; and
6) sending part of said one of said plurality of tasks to said second device.

9. The method according to claim 8 wherein said plurality of markers each are arranged distinctive.

10. The method according to claim 8 wherein each of said plurality of tasks is represented by one of said plurality of markers and one of said plurality of codes.

11. The method according to claim 8 wherein said one of said plurality of codes is submitted by manual input or verbal input of a user.

12. The method according to claim 8, further including causing said second device to perform part of said one of said plurality of tasks.

13. The method according to claim 8, further including causing a third device which is away from said first and second device to perform part of said one of said plurality of tasks.

14. The method according to claim 8 wherein the info of said object or entity is obtained from a machine-detectable signal or verbal input of a user.

15. A method performed for executing a task, comprising:
1) acquiring marker info via a device or a service system;
2) said marker info defined by at least one of a plurality of factors, said plurality of factors including a geographic location, a geographic region, an object, an entity, an image, and a time period;
3) obtaining a code comprising at least one element via said device from a user, said at least one element including a numeric number, a letter, a character, or a sign;
4) transmitting said marker info, the method used in said acquiring step, and said code to a facility;
5) receiving a message from said facility, said message related to said task; and
6) performing said task using said device according to instructions from said message.

16. The method according to claim 15 wherein said marker info and/or said code is obtained via verbal input of said user.

17. The method according to claim 15, further including causing a first system which is away from said device and said facility to perform part of said task.

18. The method according to claim 15 wherein only the info of said task and said code is presented publicly.

19. The method according to claim 15 wherein said code contains no more than three single-digit numbers plus a letter, a character, or a sign.

20. The method according to claim 15 wherein said code contains no more than three single-digit numbers.
